(19) United States
(12) Patent Application Publication
(10) Pub. No.: US 2025/0190557 A1
(43) Pub. Date: Jun. 12, 2025

(54) System and Method for Providing Emergency Operations

(71) Applicant: PC Matic Inc, Sioux City, IA (US)

(72) Inventors: Devin R. Bergin, Myrtle Beach, SC (US); Jeffery A. Fleming, Knightdale, NC (US)

(73) Assignee: PC Matic Inc, SIOUX CITY, IA (US)

(21) Appl. No.: 18/437,381

(22) Filed: Feb. 9, 2024

Related U.S. Application Data
(63) Continuation-in-part of application No. 18/533,461, filed on Dec. 8, 2023.

(51) Int. Cl. G06F 21/56

(52) U.S. Cl. CPC G06F 21/56; G06F 2221/034

(57) ABSTRACT

A system and method for invoking the emergency operations includes an initiation feature such as an application in the user's tray, an application on the user's home screen, a hardware button, a specific key sequence (e.g., Fn-V for virus), or other device input that is likely not to be invoked by mistake. Once invoked, one or more security actions are taken to prevent or reduce harm from potential malware. These actions include some or all of using a more secure whitelist, terminating running programs that are not on the whitelist (e.g., a global whitelist), setting of a firewall to restrict communications, capturing certain logfile information and transmitting this information to a security server, setting the firewall to only allow access by certain IP addresses, and blocking and/or terminating certain other programs.

### FIELD OF THE INVENTION

This invention relates to computer security and more particularly to a system and method for providing emergency help to a user that suspects malware has infiltrated the user's device.

### BACKGROUND OF THE INVENTION

Currently, many software systems attempt to provide a secure computing environment by preventing intrusions. Such systems often use lists of known safe programs (whitelists) and/or lists of known malicious programs (blacklists) to prevent malicious programs from running and affecting the user's device. Any device having a processor (including cellular phones, etc.) that is connected to a network is subject to intrusion from that network. Unfortunately, there seems to be new malware created every so often that finds its way into the user's device and causes harm to the user's device and/or data.

Today, many intrusions start with reception of malicious software, typically a script or executable. Often, the script or executable is installed on a user's device when the user attempts to read an attachment in an email or visits a malicious web page. Malicious software can also be introduced from a device that is attached that has memory.

Malicious software is typically a software program that gets installed on the user's computer or device, typically without permission or knowledge of the user. In some instances, the malicious software is delivered to the user in an email, typically an attached file, or from a web site. Upon opening of a file or clicking a link, the malicious software is copied onto the user's computer storage and either begins to run or schedules itself to run later.

To prevent such malicious software from infecting a computing environment, some anti-malware software operates on a principle of whitelists. With such, any program that is not on a whitelist (e.g., a list of approved programs) is blocked. Therefore, if malicious software is introduced to a user's computer, it will likely not be on the whitelist and, therefore, be blocked from executing. A whitelist requires users and/or administrators to constantly update their whitelists to include new programs that are needed/desired for users to perform their tasks. This is a small price to pay for the added security.

Further, users are often trained not to click on attachments unless the sender is known and they are expecting the attachment and users are trained not to access unknown web sites. Still, every day we receive tens of emails telling us our bank account was closed, we owe money to the IRS, you won a lottery, our child is in jail. All having attachments that are dangerous.

This being said, there are often times when a user falls for one of these scams and clicks on an attachment or visits a web site containing malware. Some of the viruses respond immediately, for example by locking the user's screen with a message saying that they have your data or something similar. Some viruses work in the background, for example taking over the user's email application and causing it to propagate to everyone in the user's contact list.

Today, when the user makes such a mistake and realizes that they made a mistake, either by whatever action they took not presenting the results that they expected or by the malware doing something overt just after the action, the user often does not know what to do. Many try to reboot their device, but most malware invades the device startup files, so this does no good. Today, the best thing a user can do is to completely shut down their computer and contact an information technologist professional, but many home users don't have IT personnel available and it is likely that the user does not remember what happened by the time the IT personnel have access to the user's device.

What is needed is system and method for invoking an emergency operation which takes evasive steps to prevent further damage and propagation of the malware and reports data and symptoms related to the malware to an information technology personnel.

### SUMMARY OF THE INVENTION

A system and method for invoking the emergency operations includes an initiation feature such as an application in the user's tray, an application on the user's home screen, a hardware button, a specific key sequence (e.g., Fn-V for virus), or other device input that is likely not to be invoked by mistake. Once invoked, one or more security actions are taken to prevent or reduce harm from potential malware. These actions include some or all of using a more secure whitelist, terminating certain running programs, setting of a firewall to restrict communications, capturing certain logfile information and transmitting this information to a security server, setting the firewall to only allow access by certain IP addresses, and blocking and/or terminating certain programs.

In one embodiment, a system for initiating actions when abnormal operation of a computer is realized is disclosed. The computer has a processor system and when abnormal operation of a computer is realized, computer instructions running on the processor receive an initiation signal indicating that the abnormal operation has been realized (e.g., a special key or key sequence initiate by a user of the computer). Responsive to the initiation signal, the computer instructions execute one or more security actions such as changing a whitelist to a secure whitelist, terminating a subset of programs that are running on the processor (e.g., terminating all running programs that are not in a whitelist stored on the user device), setting of a firewall to restrict communications, capturing logfile information and transmitting the logfile information to a security server, setting the firewall to restrict communications access of the computer to only certain IP addresses, or blocking operations of a second subset of programs.

In another embodiment, a device having a processor, a tangible memory, a display, a human input device, and security software running on the processor is disclosed. The security software is running on the processor from the tangible memory. The security software includes computer instructions that are running on the processor that wait for an initiation signal from a user of the device after the user suspects malware activity (e.g., a special key or key sequence initiate by a user of the computer) and responsive to the initiation signal, the computer instructions perform one or more security actions for preventing actions of a suspected malware program such as changing whitelists, changing firewall settings, terminating all running programs that are not in a whitelist stored on the user device, etc.

In another embodiment, a method of protecting a device from malware is disclosed. The device has a processor and storage. The method includes determining, by a user of the device, that there is an opportunity for intrusion by the malware, then signaling an initiation signal by the user of the device after there is the opportunity for intrusion by the malware (e.g., operation of a special key or key sequence initiate by a user of the computer). Responsive to the initiation signal, performing one or more security actions for preventing actions of the malware such as changing whitelists, changing firewall settings, terminating all running programs that are not in a whitelist stored on the user device, etc.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the computer security system with emergency operations.

FIG. 2 illustrates a schematic view of a typical user device protected by the computer security system with emergency operations.

FIG. 3 illustrates a simplified browser user interface of the typical user device of the prior art.

FIG. 4 illustrates a simplified browser user interface of the typical user device of the prior art.

FIG. 5 illustrates a simplified web page example of the of the prior art.

FIG. 6 illustrates a simplified browser user interface of the typical user device of the prior art.

FIG. 7A illustrates a first example of an activity of malware of the prior art.

FIG. 7B illustrates a second example of an activity of malware of the prior art.

FIG. 8 illustrates a simplified browser user interface of the user device including an initiation feature that invokes emergency operations.

FIG. 9 illustrates a home-screen user interface of the user device including an alternate initiation feature that invokes emergency operations.

FIGS. 10 and 11 illustrate exemplary program flows of the computer security system with emergency operations.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “device” refers to any system that has a processor and runs software. Examples of such are: a personal computer, a server, a notebook computer, a tablet computer, a smartphone, a smart watch, a smart television, etc. The term, “user” refers to a human that has an interest in the device, perhaps a person (user) who is using the device.

Throughout this description, the term, “malicious software” or “malware” refers to any software having ill-intent. Many forms of malicious software are known; some that destroy data on the host computer; some that capture information such as account numbers, passwords, etc.; some that fish for information (phishing), pretending to be a known entity to fool the user into providing information such as bank account numbers; some encrypt data on the computer and hold the data at ransom, etc. A computer virus is a form of malicious software.

Throughout this document, the term program will refer to any item that potentially runs on the device, including, but not limited to software executables, scripts, and macros.

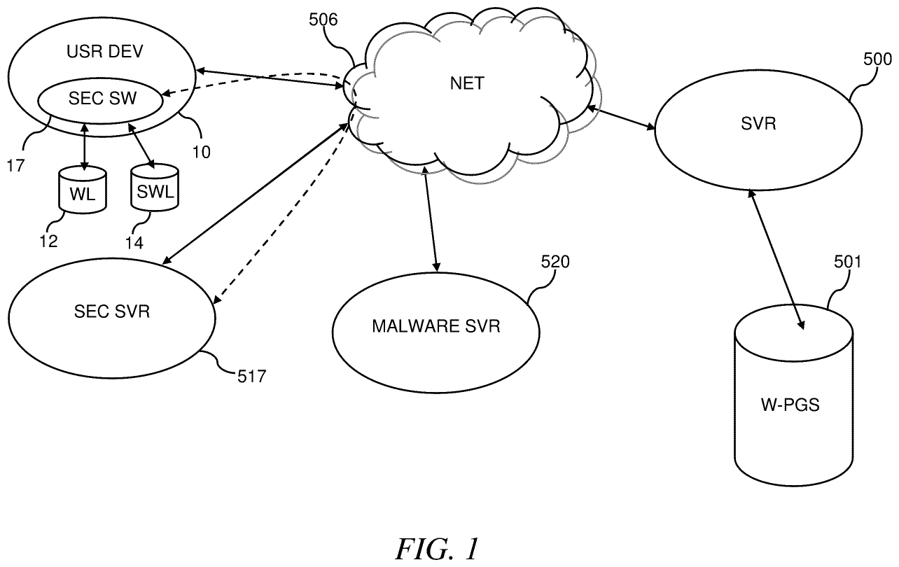

Referring to FIG. 1, a data connection diagram of a computer security system with emergency operations is shown. In this example, a user device 10 (e.g., personal computer, smartphone tablet) communicates using a browser (as known in the industry) through a network 506 (e.g., the Internet, local area network, etc.) to a server computer 500 (e.g., website) that hosts a web page to which the user is browsing. The server computer 500 has access to data storage 501 as an example, for containing data and web pages. The server computer 500 transacts with software running on the user device 10 through the network(s) 506.

In this example, there is security software 17 installed on the user device 10. The security software 17 has many ways to prevent the intrusion of malware and the security software 17, in some embodiments, has a communications link to a security server 517 for receiving update security-related files such as whitelists 12/14 and blacklists, and for transmitting suspected malware from the user device 10 to the security server 517, etc. In some embodiments, the whitelist 12 controls which programs are allowed to run on the user device 10. Also, in some embodiments, as will be discussed later, there is a second whitelist 14 that is more restrictive and is used when the user of the user device 10 signals a potential malware has been activated.

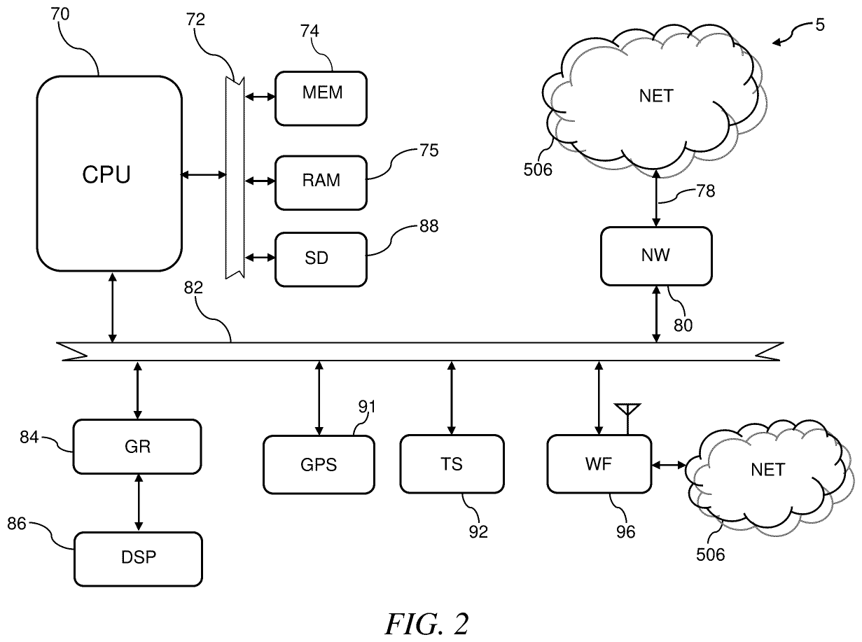

Referring to FIG. 2, a schematic view of a typical computer 5 used as an example of a user device 10, the server computer 500, and the security server 517 is shown. The present invention is in no way limited to any particular computer 5 systems. Many computers 5 that are processor-based devices are anticipated including, but not limited to smartphones, cellular phones, portable digital assistants, personal computers, smart watches, cordless phones, etc.

In some instances, the computer system 5 is shown to represent a typical user device 10 that is protected by the computer security system 17. This exemplary user device 10 is shown in its simplest form. Different architectures are known that accomplish similar results in a similar fashion, and the present invention is not limited in any way to any particular user device 10 system architecture or implementation. In this exemplary user device 10, a processor 70 executes or runs programs in a random-access memory 75. The programs are generally stored within a persistent memory 74 and loaded into the random-access memory 75 when needed. In some user devices 10, a removable storage 88 (e.g., compact flash, SD) offers removable persistent storage. The processor 70 is any processor, typically a processor designed for phones. The persistent memory 74, random-access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary user device 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceiver 96, image sensors, temperature sensors, etc., the details of which are not shown for brevity and clarity reasons.

The network interface 80 connects the user device 10 to the network 506 (e.g. Internet) through any known or future protocol such as Ethernet (IEEE 802.3), etc. There is no limitation on the type of connection used. The network interface 80 provides data connections between the user device 10 and the server computer 500 and the security server 517 through any network 506. In some embodiments, the Wi-Fi transceiver 96 is used to connect to the network 506.

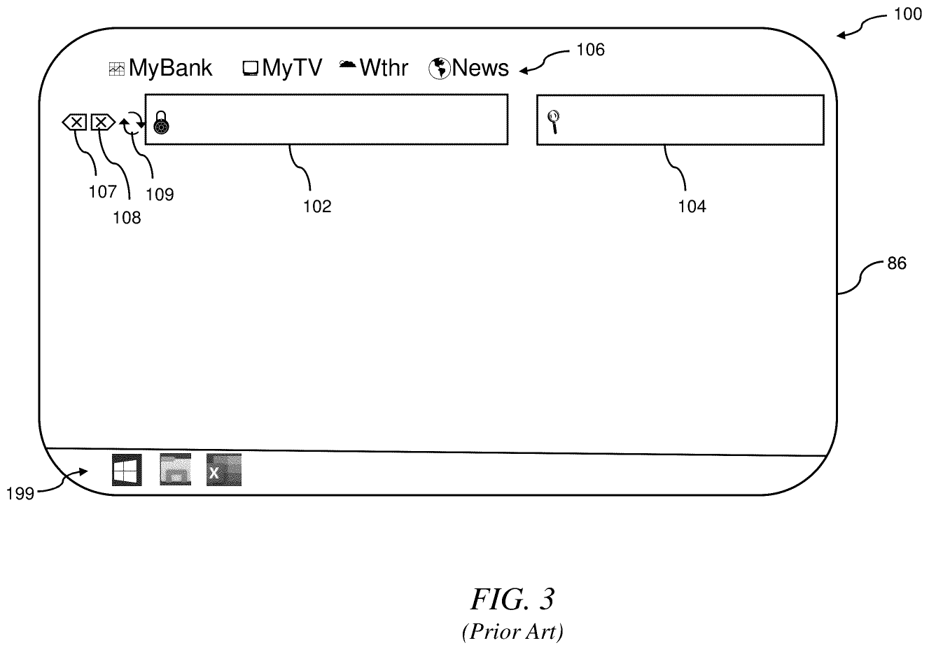

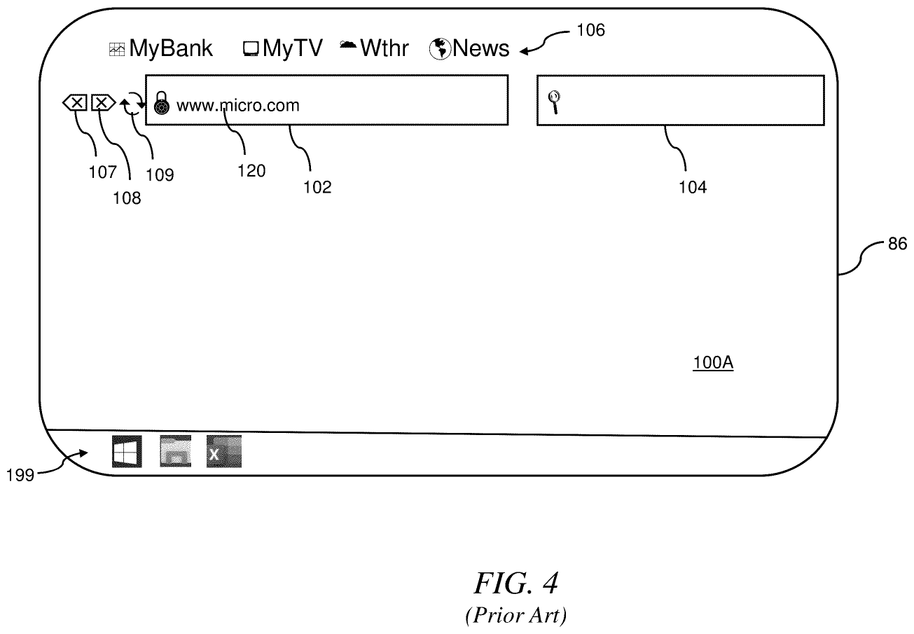

Referring to FIGS. 3 and 4, a simplified browser user interface 100 of the typical user device 10 of the prior art is shown. In both figures, the simplified browser user interface 100 shown has several pre-stored links 106 to frequently browsed websites, a back navigation button 107, a forward navigation button 108, and a refresh button 109. As with many such browser user interfaces, there is a place to enter a web address 102 (e.g., a Unified Resource Locator or URL) or a search term 104.

As is shown in FIGS. 3-7B, there is a taskbar 199 that provides a single click operation to open whatever applications/files are installed on the taskbar 199. In these examples, the taskbar 199 is at the bottom to the display 86, but it is known to relocate the taskbar 199 or to hide the taskbar 199. Often, when the taskbar is hidden, there is a specific key that will cause the taskbar 199 to be displayed in the desired location on the display 86.

In the simplified browser user interface 100A of FIG. 4, a user has entered a web address 120 into the place to enter a web address 102 so that the user can visit the web page at www.micro.com.

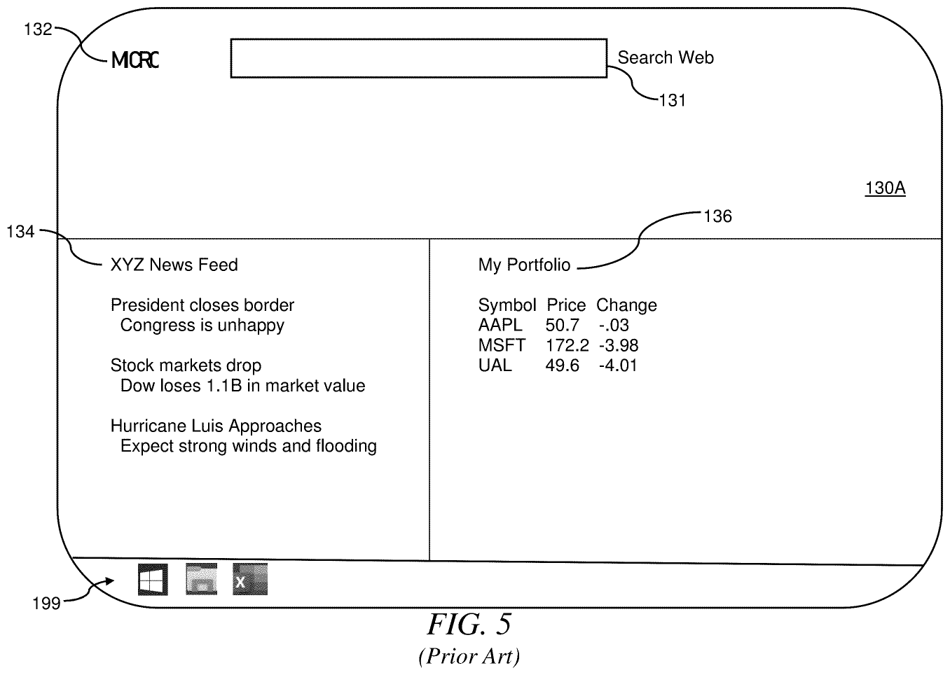

Referring to FIG. 5, a simplified web page example 130B of the of the prior art is shown. This is an example of what the user has found at the web address “micro.com”. As an example, this simplified web page example 130A has a title 132, a place to enter a search term 131, some news links 134 and some stock market information 136. The content of this simplified web page example 130A is not important, only the fact that the user correctly typed the web address 120 and reached the correct simplified web page example 130A.

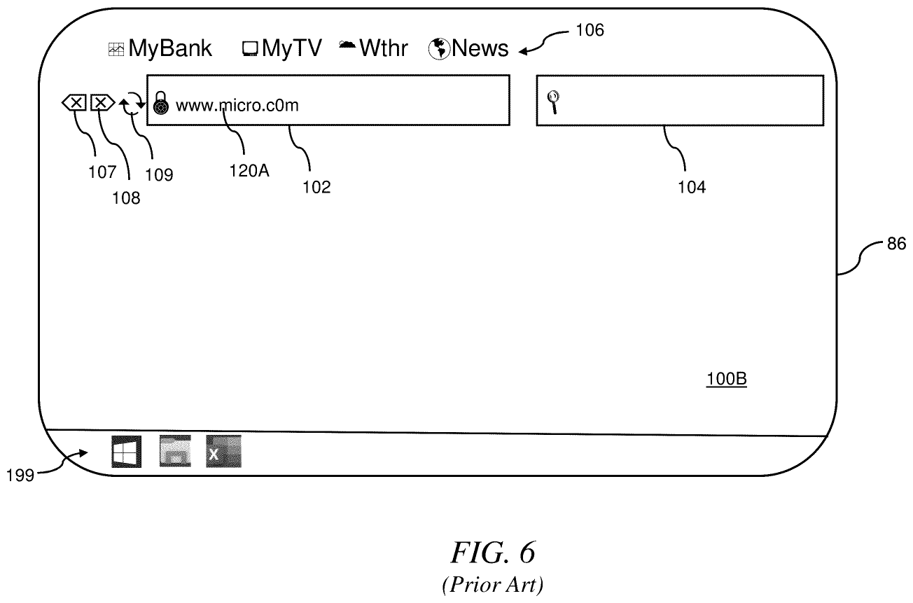

Referring to FIG. 6, another simplified browser user interface 100B of the typical user device 10 of the prior art is shown. As with FIGS. 3 and 4, the simplified browser user interface 100B shown has several pre-stored links 106 to frequently browsed websites, a back navigation button 107, a forward navigation button 108, and a refresh button 109. As with many such browser user interfaces, there is a place to enter a web address 102 (e.g., a Unified Resource Locator or URL) or a search term 104.

In this case, the user has entered a web address 120A into the place to enter a web address 102 so that the user can visit the web page at www.micro.com, but has mistyped “www.micro.com.” Instead of an ‘o’, the user has typed a zero (‘0’) as in www.micro.c0m. This is a common mistake.

Knowing that users often mistype common web addresses, many companies occupy these web addresses that are similar to the common web addresses. For example, one might occupy google.com, whitehouse.com (instead of whitehouse.gov), irs.com (instead of irs.gov or treasury.gov), etc. Some of these companies do provide services, as one might imagine, a company that prepares tax returns might be interested in those visiting “irs.com.” On the other hand, some of these companies are not legitimate operations or, in the least, not websites that the user actually planned to visit.

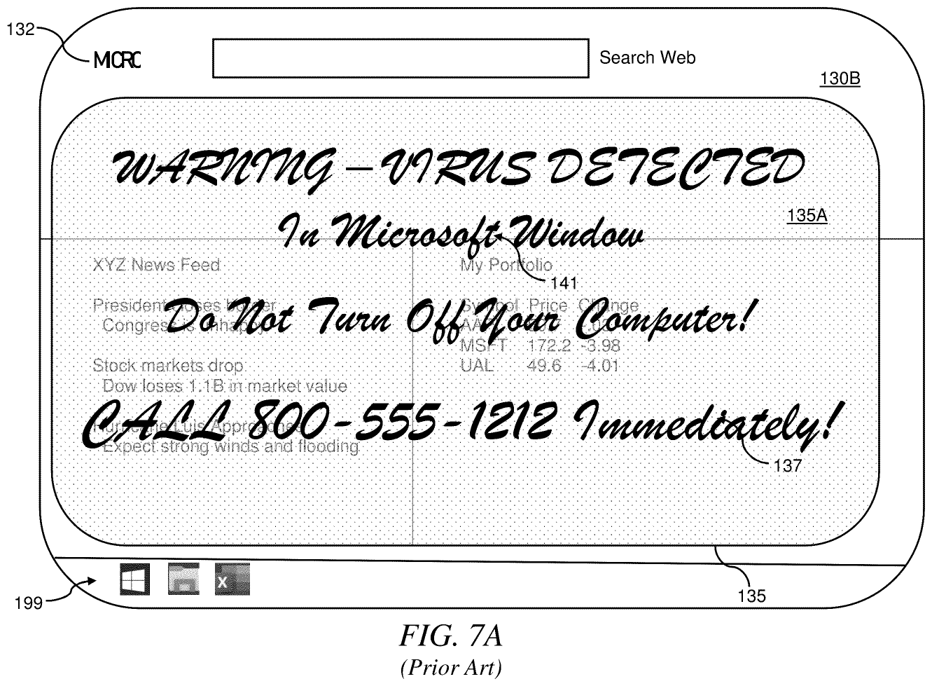

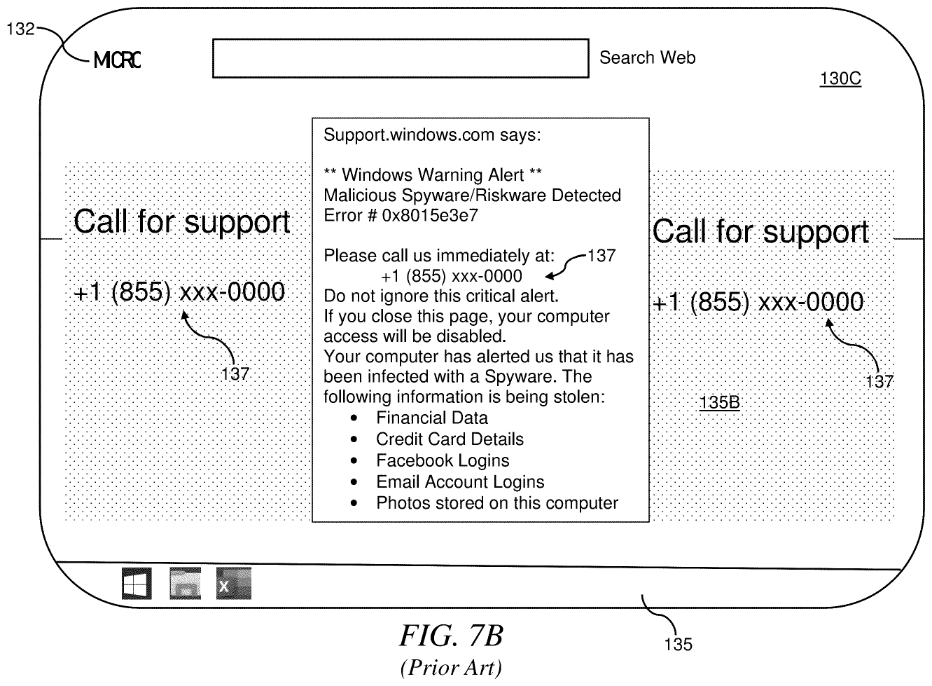

Referring to FIG. 7A, a first example of a malware screen 135A of the prior art is shown. This malware screen 135A includes a strongly worded warning message 135 that includes a company name 141 that helps make the strongly worded warning message 135 appear legitimate and usually includes a phone number 137 to which this company hopes the user will call. In some malware screens 135A, an alert is made telling the user that they have performance issues or any other issue.

Upon calling the phone number, an operator at the other end will request information from the user. Some such companies are only looking to charge the user a fee for removing the virus, but providing a credit card, expiration date, and security code to these companies is a dangerous thing. Some companies do much worse. For example, once the trust of the user is gained, the operator will request the user navigate to the company's web site and execute one or more commands which will allow the operator full control and access to the user device 10. This allows the operator to install various malware programs, relax security of the user device 10, and even extract files that the company can later use to thwart security, access sensitive data, etc. Nothing good comes of calling this phone number.

Referring to FIG. 7B, a second example of a malware screen 130C of the prior art is shown. This malware screen 130C includes a strongly worded warning message 135B that is made realistic to help make the strongly worded warning message 135B appear legitimate. The strongly worded warning message 135B includes a phone number 137 to which this company hopes the user will call.

As with FIG. 7A, upon calling the phone number, an operator at the other end will request information from the user. Some such companies are only looking to charge the user a fee for removing the virus, but providing a credit card, expiration date, and security code to these companies is a dangerous thing. Some companies do much worse. For example, once the trust of the user is gained, the operator will request the user navigate to the company's web site and execute one or more commands which will allow the operator full control and access to the user device 10. This allows the operator to install various malware programs, relax security of the user device 10, and even extract files that the company can later use to thwart security, access sensitive data, etc. Nothing good comes of calling this phone number.

Once the user makes a mistake (e.g., by browsing to one of these malware web sites), time is critical as in seconds, some malware begins encrypting user data, infiltrating the user's contact list, copying user data files to the malware server 520, etc. Some knowledgeable users might shut off their device 10 to prevent some of these actions, but these actions will restart once the user reboots the device 10.

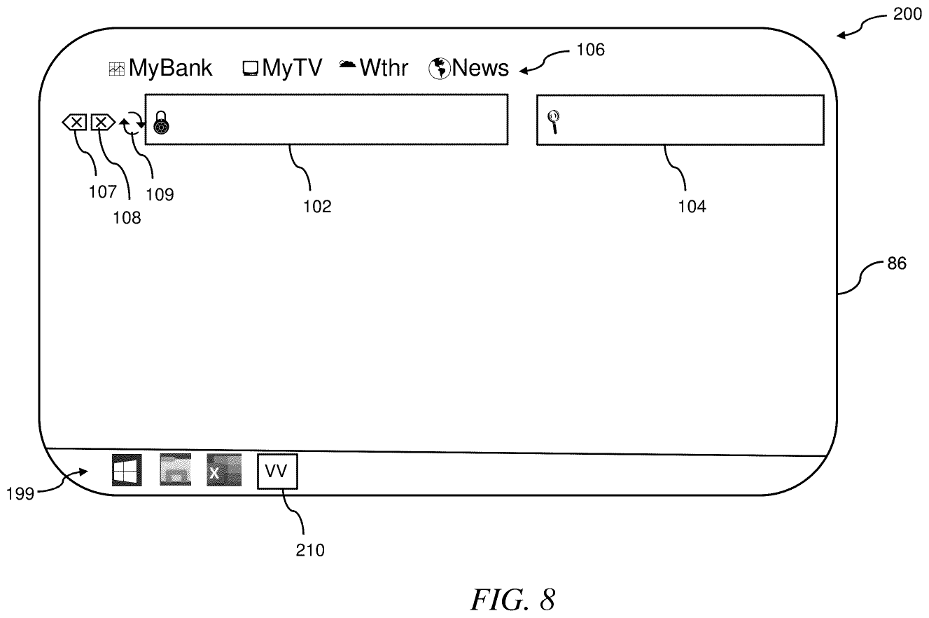

Referring to FIG. 8, a simplified browser user interface 200 of the user device is shown including a taskbar initiation feature 210 of the computer security system with emergency operations in the taskbar 199. Activation of the taskbar initiation feature 210 invokes emergency operations as described below. As above, the simplified browser user interface 100 shown has several pre-stored links 106 to frequently browsed websites, a back navigation button 107, a forward navigation button 108, and a refresh button 109. As with many such browser user interfaces, there is a place to enter a web address 102 (e.g., a Unified Resource Locator or URL) or a search term 104.

As above, there is a taskbar 199 that provides a single click operation to open whatever applications/files are installed on the taskbar 199. In these examples, the taskbar 199 is at the bottom to the display 86, but it is known to relocate the taskbar 199 or to hide the taskbar 199. Often, when the taskbar is hidden, there is a specific key that will cause the taskbar 199 to be displayed in the desired location on the display 86.

In this, the taskbar 199 includes a taskbar initiation feature 210. When the user clicks on the taskbar initiation feature 210, the emergency operations, as will be described, will initiate to prevent or reduce harm from potential malware. It is anticipated that, when the user believes they have navigated to a malware location, opened a file or link that is likely to be malware, or has symptoms of malware as in FIGS. 7A and 7B, the user invokes the taskbar initiation feature 210 to prevent or reduce damage due to the potential or perceived malware.

As the taskbar 199 is not always visible on the display 86, there is often a keyboard key that will cause the taskbar 199 to be displayed (e.g., often called the “windows key”). If it is impossible to display the taskbar 199 (e.g., when malware prevents any operations or changes to the display 86) or as an alternative initiation feature, it is anticipated that there be specific initiation key sequence such as Fn+V that will invoke the emergency operations.

When the user initiates the emergency operations by, for example, invoking the taskbar initiation feature 210, invoking the home-screen user interface 210A, or by entering the initiation key sequence, the security software 17 increases device security while capturing valuable information regarding the malware.

In some embodiments, the emergency operations initiated by the security software 17 includes a strict allowlisting (or whitelisting) mode. In normal operations, the security software uses a whitelist 12 to determine which programs are allowed to run on the user device 10. In this embodiment, after the emergency operations are initiated, a more restricted, second whitelist 14 is used that provides strict allowlisting (or whitelisting) in which only operating system files and known security software 17 programs are allowed to run. In some embodiments, when there is a corporate whitelist and a local whitelist, only programs listing in the corporate whitelist are allowed to run. In strict allowlisting (or whitelisting) mode, no programs or applications of the company or user are allowed to run as such may have been infiltrated by the malware. Only files and programs that are necessary to keep the device 10 functioning are allowed to be accessed and/or run.

In some embodiments, the emergency operations initiated by the security software 17 includes terminating any program that is running on the device 10 that is not part of the security software 17 or part of the operating system. In some embodiments, any program that is not listed in the whitelist 12/14 is terminated. For example, if a user has given temporary permission for a program to run, overriding the whitelist 12/14, and that program is running, it will be terminated, as it is not in the whitelist 12/14. In another example, if the malware is able to run a program, that program is likely not in the whitelist 12/14 and is terminates as well.

In some embodiments, the emergency operations initiated by the security software 17 includes making changes to windows firewall settings that will block communications traffic (e.g., access to the network 506) except for communications to and from the security server 517. This prevents the malware from communicating to any external servers (e.g., the malware server 520) either for sending data or for downloading other payloads.

In some embodiments, the emergency operations initiated by the security software 17 includes capturing logfile information (and any other pertinent information such as the list of tasks that are running) and sending the logfile information along with an alert to the security server 517. Responsive to the alert, the security server 517 will alert IT staff that a user has initiated emergency operations. These logfiles will provide the most needed information to IT immediately, without requiring a communication from the user.

In some embodiments, the emergency operations initiated by the security software 17 includes setting administrative configurable functions. For example, adjusting the firewall to only allow inbound traffic from certain IP Addresses, such as the security server 517, allowing a remote connection from security administration personnel.

In some embodiments, the emergency operations initiated by the security software 17 includes disabling remote desktop protocol (RDP) on the device 10 to ensure any rogue RDP connections by the malware to/from a foreign computer (e.g., malware server 520) are stopped.

In some embodiments, the emergency operations initiated by the security software 17 includes blocking scripting engines such as powershell (even though some such scripting engines are operating system files—e.g., powershell) to further reduce the ability of the malware to do harm.

The combination of any or all, or even additional emergency operations, based upon a single invocation by the user presents a valuable feature of the security software 17 by providing exposure of a potential breach and malware activity.

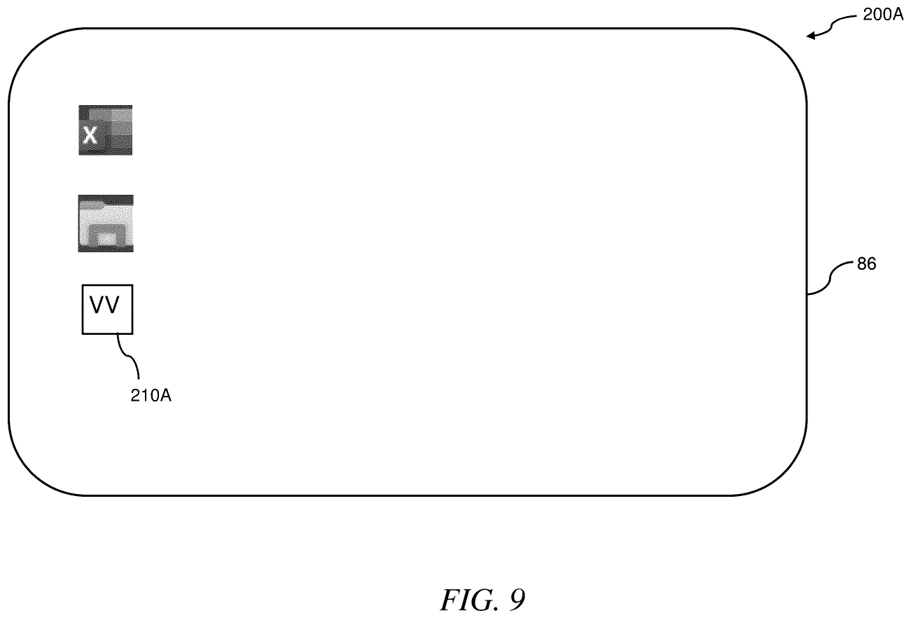

Referring to FIG. 9, a simplified home-screen user interface 200A of the user device 10 is shown including the home-screen user interface 210A. When the user sees activities that are indicative of malware infiltrating their device 10 or when the user is cautious after, for example, opening a suspicious file or clicking on a suspicious link, the user will invoke the home-screen user interface 210A and the emergency operations, as described above, start.

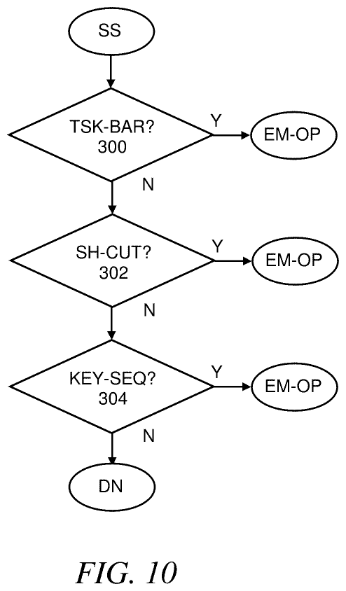

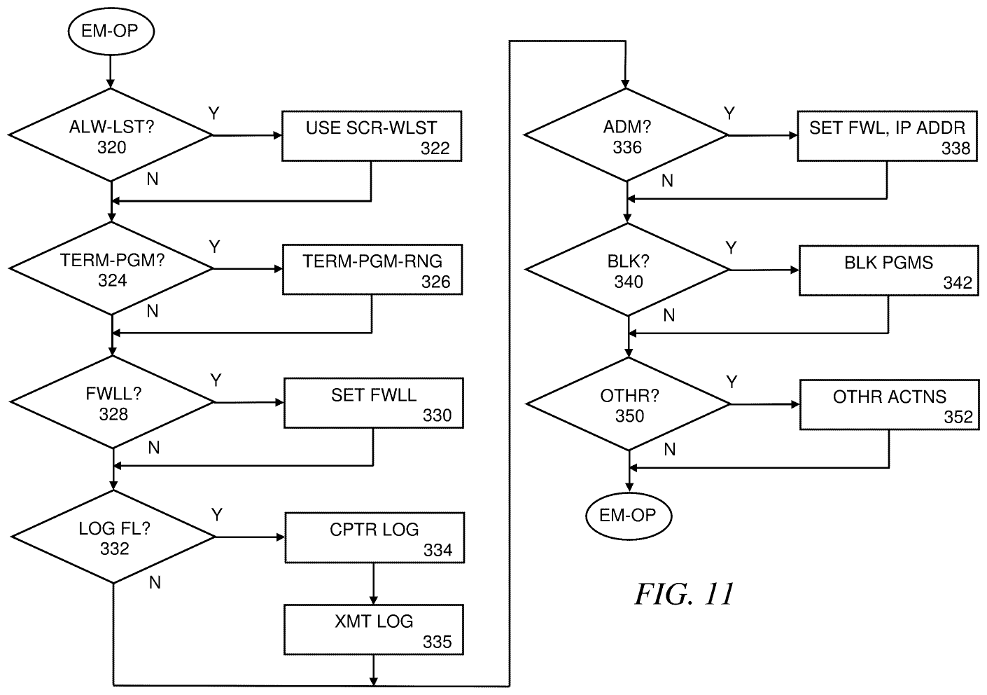

Referring to FIGS. 10 and 11, exemplary program flow diagrams of the computer security system with emergency operations. In FIG, 10, the security software 17 monitors whichever type of initiation sequence is used by the security software 17. In this example, when the taskbar initiation feature 210 is invoked 300, the emergency operations of FIG. 11 are initiated. Likewise, when the home-screen user interface 210A is invoked 302, the emergency operations of FIG. 11 are initiated. Alternately, when the initiation key sequence is detected 304, the emergency operations of FIG. 11 are initiated.

In FIG. 11, various security features are optionally provided in response to the initiation/activation of FIG. 10. When the user initiates the emergency operations by, for example, invoking the taskbar initiation feature 210, invoking the home-screen user interface 210A, or by entering the initiation key sequence, the security software 17 increases device security while capturing valuable information regarding the malware, as for example, using the program flow of FIG. 11.

When the secure whitelist feature is enabled 320, the emergency operations initiated by the security software 17 enters a strict allowlisting (or whitelisting) mode 322. In normal operations, the security software uses a whitelist 12 to determine which programs are allowed to run on the user device 10. In this, after the emergency operations are initiated, a more restricted, second whitelist 14 is used that provides strict allowlisting (or whitelisting) in which only operating system files and known security software 17 programs are allowed to run. In strict allowlisting (or whitelisting) mode, no programs or applications of the company or user are allowed to run as such may have been infiltrated by the malware. Only files and programs that are necessary to keep the device 10 functioning are allowed to be accessed and/or run.

When the terminate programs feature is enabled 324, the emergency operations initiated by the security software 17 includes terminating 326 any program that is running on the device 10 that is not part of the security software 17 or part of the operating system.

When the secure firewall feature is enabled 328, the emergency operations initiated by the security software 17 includes making changes to firewall settings 330 that will block communications traffic (e.g., access to the network 506) except for communications to and from the security server 517. This prevents the malware from communicating to any external servers (e.g., the malware server 520) either for sending data or for downloading other payloads.

When the logfile/data feature is enabled 332, the emergency operations initiated by the security software 17 includes capturing 334 logfile information (and any other pertinent information such as the list of tasks that are running) and sending 335 the logfile information along with an alert to the security server 517. Responsive to the alert, the security server 517 will alert IT staff that a user has initiated emergency operations. These logfiles will provide the most needed information to IT immediately, without requiring a communication from the user.

When the change administration parameters feature is enabled 336, the emergency operations initiated by the security software 17 includes setting 338 administrative configurable functions. For example, adjusting the firewall to only allow inbound traffic from certain IP Addresses, such as the security server 517, allowing a remote connection from security administration personnel.

When the blocking feature is enabled 340, the emergency operations initiated by the security software 17 includes disabling blocking/terminating 342 of certain programs that are often used by malware such remote desktop protocol (RDP) on the device 10 to ensure any rogue RDP connections by the malware to/from a foreign computer (e.g., malware server 520) are stopped. In some embodiments, the emergency operations initiated by the security software 17 includes blocking/terminating 342 scripting engines such as powershell (even though some such scripting engines are operating system files-e.g., powershell) to further reduce the ability of the malware to do harm.

When any other anticipated security feature is enabled 350, the emergency operations include performing 352 such other actions. The combination of any or all, or even additional emergency operations, based upon a single invocation by the user presents a valuable feature of the security software 17 by providing exposure of a potential breach and malware activity.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for initiating actions when potential of intrusion by malware of a computer is realized, the computer having a processor, the system comprising:
computer instructions running on the processor receive an initiation signal indicating that the intrusion by the malware has been realized; and
responsive to the initiation signal, the computer instructions execute one or more security actions selected from a group consisting of:
changing a whitelist to a secure whitelist,
terminating all programs that are running on the processor and are not in the whitelist,
setting of a firewall to restrict communications,
capturing logfile information and transmitting the logfile information to a security server,
setting the firewall to restrict communications access of the computer to only certain IP addresses, and
blocking operations of a second subset of programs.

2. The system of claim 1, wherein the initiation signal comprises activation of a preset key sequence or combination of keys on a keyboard, the keyboard operationally interfaced to the computer.

3. The system of claim 1, wherein the initiation signal comprises activation of a dedicated switch.

4. The system of claim 1, wherein the initiation signal comprises invoking a program from a home screen of a display of the computer.

5. The system of claim 1, wherein the initiation signal comprises invoking a program from a task bar on a display of the computer.

6. The system of claim 1, wherein the secure whitelist comprises entries that are required for operation of the computer and entries that are required for operation of security software on the computer.

7. The system of claim 1, wherein the whitelist is a global whitelist as opposed to a local whitelist.

8. A device having a processor, a tangible memory, a display, a human input device, and security software running on the processor, the security software running on the processor from the tangible memory comprising:
computer instructions running on the processor that wait for an initiation signal indicative of a suspected malware activity; and
responsive to the initiation signal, the computer instructions perform one or more security actions for preventing actions of a suspected malware program, the one or more security actions comprising at least terminating all running programs that are not in a whitelist stored in the tangible memory of the device.

9. The device of claim 8, wherein the initiation signal is selected from a group consisting of a preset key sequence from the human input device, a combination of keys pressed on the human input device, activation of a dedicated switch, invoking a program from a home screen of the display, and invoking an application from a task bar on the display.

10. The device of claim 8, wherein the one or more security actions comprise computer instructions running on the processor that change the whitelist to a secure whitelist.

11. The device of claim 8, wherein the one or more security actions comprise computer instructions running on the processor that terminate a subset of programs that are running on the processor.

12. The device of claim 8, wherein the one or more security actions comprise computer instructions running on the processor that set a firewall to restrict communications.

13. The device of claim 8, wherein the one or more security actions comprise computer instructions running on the processor that capture logfile information and transmitting the logfile information to a security server.

14. The device of claim 8, wherein the one or more security actions comprise computer instructions running on the processor that set a firewall to restrict communications access of the device to only certain IP addresses.

15. The device of claim 8, wherein the one or more security actions comprise computer instructions running on the processor that block operations of a second subset of programs.

16. The device of claim 10, wherein the secure whitelist comprises entries that are required for operation of the device and entries that are required for operation of security software on the device.

17. A method of protecting a device from malware, the device having a processor and storage, the method comprising:
determining, by a user of the device, that there is an opportunity for intrusion by the malware;
signaling an initiation signal after suspecting that there is the opportunity for intrusion by the malware; and
responsive to the initiation signal, performing one or more security actions for preventing actions of the malware comprising at least terminating all running programs that are not in a whitelist stored on the storage of the device.

18. The method of claim 17, wherein the initiation signal is selected from a group consisting of the user invoking a preset key sequence from a human input device that is operatively interfaced to the device, the user invoking a combination of keys pressed on the human input device that is operatively interfaced to the device, the user invoking a dedicated switch that is operatively interfaced to the device, the user invoking a program from a home screen of a display that is operatively interfaced to the device, and the user invoking the program from a task bar on the display.

19. The method of claim 17, wherein the one or more security actions comprise changing the whitelist to a secure whitelist.

20. The method of claim 17, wherein the one or more security actions comprise an action selected from a group consisting of terminating a subset of programs that are running on the processor, setting of a firewall to restrict communications, capturing logfile information and transmitting the logfile information to a security server, setting the firewall to restrict communications access of the device to only certain IP addresses, and blocking operations of a second subset of programs.
